(19) United States
(12) Patent Application Publication
(10) Pub. No.: US 2023/0079182 A1
(43) Pub. Date: Mar. 16, 2023

(54) METHOD AND USER EQUIPMENT FOR EARLY EVALUATION TERMINATION

(71) Applicant: MEDIATEK INC., Hsin-Chu (TW)

(72) Inventors: Yi-Ru Chen, Hsin-Chu (TW); Kuan-Hung Chou, Hsin-Chu (TW); Li-Chuan Tseng, Hsin-Chu (TW); Chia-Chun Hsu, Hsin-Chu (TW)

(21) Appl. No.: 17/878,536

(22) Filed: Aug. 1, 2022

Related U.S. Application Data
(60) Provisional application No. 63/240,439, filed on Sep. 3, 2021.

(51) Int. Cl. H04W 76/19; H04B 7/08; H04W 24/10; H04L 5/00

(52) U.S. Cl. CPC H04W 76/19; H04B 7/088; H04W 24/10; H04L 5/0051

(57) ABSTRACT

Method and user equipment (UE) are provided for early evaluation termination. In particular, a UE can receive a downlink (DL) reference signal (RS) from a network. The UE can measure the DL RS to derive a measurement. Then, the UE can adjust a time value or a count value based on the measurement. The time value is configured by the network for triggering measurement reporting procedure or declaring a radio link failure. The count value is configured by the network for triggering beam failure recovery or random access procedure.

### CROSS REFERENCE TO RELATED APPLICATIONS

This application claims priority under 35 U.S.C. § 119 from U.S. Provisional Application No. 63/240,439, entitled “Method of UE-initiated Early Evaluation Termination,” filed on Sep. 3, 2021, the subject matter of which is incorporated herein by reference.

### TECHNICAL FIELD

The disclosed embodiments relate generally to wireless communication, and, more particularly, to method and user equipment for early evaluation termination.

### BACKGROUND

In conventional network of 3rd generation partnership project (3GPP) 5G new radio (NR), a network configured time value or count value for some procedures is introduced to prevent false alarm. For example, a network configured time value is introduced for a user equipment (UE) to trigger measurement reporting procedure for handover procedure, another network configured time value is introduced for the UE to declare a radio link failure, and a network configured count value is introduced for the UE to trigger beam failure recovery or random access procedure.

However, all these time values and count value are configured by the network and are constant until the UE received network re-configuration, which cannot be dynamically adjusted by the UE and may cause significant waste of time (i.e., UE evaluation delay) for the UE to wait for triggering or declaring the corresponding procedures.

### SUMMARY

Method and user equipment (UE) are provided for early evaluation termination. In particular, a UE can receive a downlink (DL) reference signal (RS) from a network. The UE can measure the DL RS to derive a measurement. Then, the UE can adjust a time value or a count value based on the measurement. The time value is configured by the network for triggering measurement reporting procedure or declaring a radio link failure. The count value is configured by the network for triggering beam failure recovery procedure.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary 5G new radio network for early evaluation termination in accordance with embodiments of the current invention.

FIG. 2 is a simplified block diagram of the cell and the UE in accordance with embodiments of the current invention.

FIG. 3 illustrates one embodiment of message transmissions in accordance with embodiments of the current invention.

FIG. 4 illustrates one embodiment of message transmissions in accordance with embodiments of the current invention.

FIG. 5 illustrates one embodiment of message transmissions in accordance with embodiments of the current invention.

FIG. 6 illustrates one embodiment of message transmissions in accordance with embodiments of the current invention.

FIG. 7 is a flow chart of a method of early evaluation termination in accordance with embodiments of the current invention.

FIG. 8 is a flow chart of a method of early evaluation termination in accordance with embodiments of the current invention.

FIG. 9 is a flow chart of a method of early evaluation termination in accordance with embodiments of the current invention.

FIG. 10 is a flow chart of a method of early evaluation termination in accordance with embodiments of the current invention.

FIG. 11 is a flow chart of a method of early evaluation termination in accordance with embodiments of the current invention.

### DETAILED DESCRIPTION

Reference will now be made in detail to some embodiments of the invention, examples of which are illustrated in the accompanying drawings.

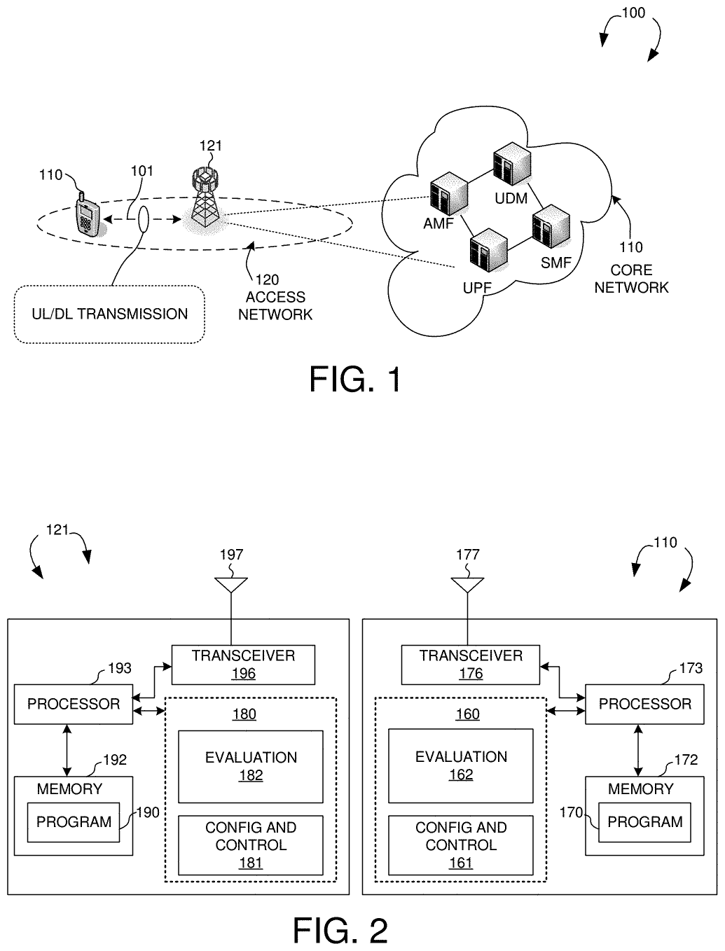

FIG. 1 illustrates an exemplary 5G new radio (NR) network 100 for early evaluation termination in accordance with aspects of the current invention. The 5G NR network 100 includes a user equipment (UE) 110 communicatively connected to a cell 121 operating in a licensed band (e.g., 30 GHz-300 GHz for mmWave) of an access network 120 which provides radio access using a Radio Access Technology (RAT) (e.g., the 5G NR technology). The access network 120 is connected to a 5G core network 130 by means of the NG interface, more specifically to a User Plane Function (UPF) by means of the NG user-plane part (NG-u), and to a Mobility Management Function (AMF) by means of the NG control-plane part (NG-c). One cell can be connected to multiple UPFs/AMFs for the purpose of load sharing and redundancy. The UE 110 may be a smart phone, a wearable device, an Internet of Things (IoT) device, and a tablet, etc. Alternatively, UE 110 may be a Notebook (NB) or Personal Computer (PC) inserted or installed with a data card which includes a modem and RF transceiver(s) to provide the functionality of wireless communication.

The cell 121 may provide communication coverage for a geographic coverage area in which communications with the UE 110 is supported via a communication link 101. The communication link 101 shown in the 5G NR network 100 may include uplink (UL) transmissions from the UE 110 to the cell 121 (e.g., on the Physical Uplink Control Channel (PUCCH) or Physical Uplink Shared Channel (PUSCH)) or downlink (DL) transmissions from the cell 121 to the UE 110 (e.g., on the PDCCH or Physical Downlink Shared Channel (PDSCH)). The cell 121 may communicate with another cell (not shown) via a communication link between the cells.

FIG. 2 is a simplified block diagram of the cell 121 and the UE 110 in accordance with embodiments of the present invention. For the cell 121, an antenna 197 transmits and receives radio signal. A radio frequency (RF) transceiver module 196, coupled with the antenna, receives RF signals from the antenna, converts them to baseband signals and sends them to processor 193. RF transceiver 196 also converts received baseband signals from the processor 193, converts them to RF signals, and sends out to antenna 197. Processor 193 processes the received baseband signals and invokes different functional modules and circuits to perform features in the cell 121. Memory 192 stores program instructions and data 190 to control the operations of the cell 121.

Similarly, for the UE 110, antenna 177 transmits and receives RF signals. RF transceiver module 176, coupled with the antenna, receives RF signals from the antenna, converts them to baseband signals and sends them to processor 173. The RF transceiver 176 also converts received baseband signals from the processor 173, converts them to RF signals, and sends out to antenna 177. Processor 173 processes the received baseband signals and invokes different functional modules and circuits to perform features in the UE 110. Memory 172 stores program instructions and data 170 to control the operations of the UE 110.

The cell 121 and the UE 110 also include several functional modules and circuits that can be implemented and configured to perform embodiments of the present invention. In the example of FIG. 2, the cell 121 includes a set of control functional modules and circuit 180. Evaluation circuit 182 handles early evaluation termination for some procedures and associated network parameters for the UE 110. Configuration and control circuit 181 provides different parameters to configure and control the UE 110. The UE 110 includes a set of control functional modules and circuit 160 from the cell 121. Evaluation circuit 162 handles early evaluation termination for some procedures and associated network parameters. Configuration and control circuit 161 handles configuration and control parameters from the cell 121.

Note that the different functional modules and circuits can be implemented and configured by software, firmware, hardware, and any combination thereof. The function modules and circuits, when executed by the processors 193 and 173 (e.g., via executing program codes 190 and 170), allow the cell 121 and the UE 110 to perform embodiments of the present invention.

In some embodiments, the UE 110 receives a network configuration (not shown) from a cell (e.g., the cell 121 or another cell). The network configuration includes at least one of: (1) a first time value (e.g., time value of “timeToTrigger” according to 3GPP Technical Specification) for triggering measurement reporting procedure; (2) a second time value (e.g., time value of “T310” according to 3GPP Technical Specification) for declaring a radio link failure (RLF); and (3) a count value (e.g., count value of “beamFailureInstanceMaxCoount” according to 3GPP Technical Specification) for triggering beam failure recovery (BFR) or random access (RA) procedure. Then, the UE 110 is configured with at least one of the first time value, the second time value and the count value.

In different network procedures, the UE 110 may measure a DL reference signal (RS) transmitted form the cell 121 to derive a measurement and adjust: (1) the first time value (which is for triggering the measurement reporting procedure); (2) the second time value (which is for declaring the RLF); or (3) the count value (which is for triggering the BFR or the RA procedure) according to the measurement. Accordingly, because the time values and count value used in different procedures can be dynamically adjusted, significant waste of time (i.e., UE evaluation delay) for the UE 110 to wait for triggering or declaring the corresponding procedures can be prevented.

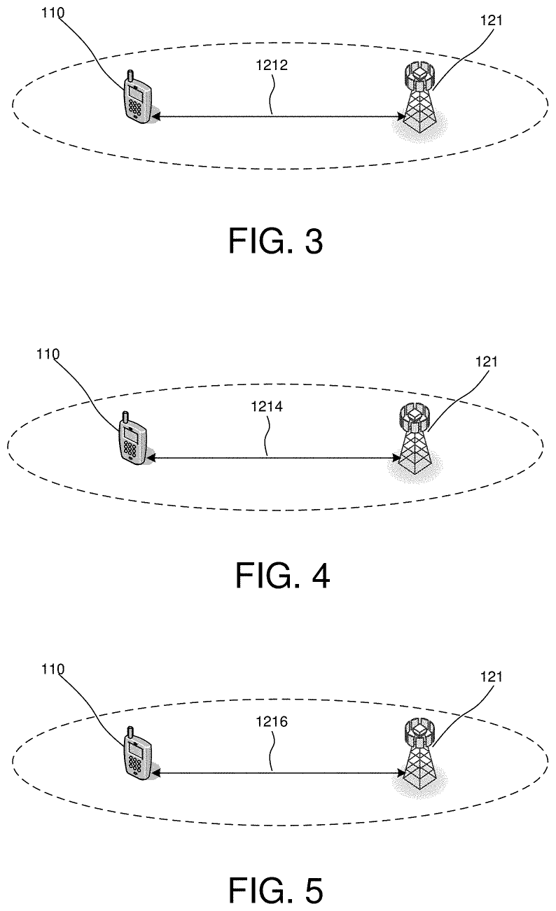

FIG. 3 illustrate some embodiments of message transmissions in accordance with one novel aspect. In particular, the cell 121 is a serving cell serving the UE 110, and the network configuration includes the first time value (e.g., “timeToTrigger” according to 3GPP Technical Specification) used for measurement reporting.

In these embodiments, the UE 110 measures a DL RS 1212 transmitted from the cell 121 to derive a measurement, and periodically updates the measurement (i.e., re-measures the DL RS 1212 to derive updated measurement).

When the measurement is measured or updated (i.e., when the UE 110 re-measures the DL RS 1212 to derive updated measurement), the UE 110 compares the updated measurement with at least one threshold and determines a state based on a result of comparing the updated measurement with the at least one threshold. Then, the UE 110 determines a scaling factor corresponding to the state, and adjusts the first time value based on the scaling factor.

Next, the UE 110 determines whether an event condition is fulfilled. More specifically, the UE 110 measures signal(s) of neighbor cell(s) and determines if there is any measurement of neighbor cell being specific margins greater than the measurement of the cell 121. When there is a measurement of a specific neighbor cell being the specific margins greater than the measurement of the cell 121 (i.e., when the event condition is fulfilled), the UE 110 starts a timer of measurement reporting for the specific neighbor cell.

Then, the UE 110 keeps monitoring the timer of measurement reporting for the specific neighbor cell. When the timer of measurement reporting for the specific neighbor cell reaches the adjusted first time value, the UE 110 performs measurement reporting procedure to transmit a measurement report to the cell 121 for handover procedure.

It should be note that, in these embodiments, the measurement may be a layer one-filtered (L1-filtered) or layer three-filtered (L3-filtered) measurement quantity, and the measurement quantity may be RSRP, RSRQ, SINR, etc. The at least one threshold may be pre-configured by the network 100. The adjusted first time value may be used for all timers of measurement reporting corresponding to the neighbor cells.

For example, the UE 110 measures the DL RS 1212 from the cell 121 to derive a measurement ‘R1’, and periodically updates the measurement ‘R1’. When the measurement ‘R1’ is measured or updated, the UE 110 compares the measurement ‘R1’ with M1 number of thresholds, and determines a state and a scaling factor corresponding to the state according to the below table 1.

TABLE 1

| | | Scaling factor |
|---|---|---|
| State | Criterion | (0 ≤ K1ᵢ ≤ 1) |
| 1 | Threshold₁ ≤ R1 | K1₁ |
| 2 | Threshold₂ ≤ R1 < Threshold₁ | K1₂ |
| 3 | Threshold₃ ≤ R1 < Threshold₂ | K1₃ |
| . . . | . . . | . . . |
| M | Threshold_{M1} ≤ R1 < Threshold_{M1-1} | K1_{M1} |

In this example, the measurement ‘R1’ is determined between the threshold₂ and threshold₃. Therefore, the state is determined as ‘3’ and the corresponding scaling factor is determined as ‘K1₃’. Then, a time value ‘TTT1’ of timeToTrigger of measurement reporting is adjusted by being multiplied by ‘K1₃’.

Next, the UE 110 determines there is a measurement ‘R2’ of a neighbor cell ‘A’ being ‘N’ margins greater than the measurement ‘R1’ of the cell 121 so that the UE 110 starts a timer ‘T_{A}’ of measurement reporting for the neighbor cell ‘A’.

Then, the UE 110 keeps monitoring the timer ‘T_{A}’ of measurement reporting for the neighbor cell ‘A’. When the timer ‘T_{A}’ of measurement reporting for the neighbor cell ‘A reaches the adjusted time value ‘TTT1’, the UE 110 triggers a measurement reporting to transmit a measurement report to the cell 121 for handover procedure.

FIG. 4 illustrates some embodiments of message transmissions in accordance with one novel aspect. In particular, the cell 121 is a neighboring cell to the UE 110, and the network configuration includes the first time value (e.g., “timeToTrigger” according to 3GPP Technical Specification) used for measurement reporting.

In these embodiments, the UE 110 measures a DL RS from a serving cell (not shown) to derive a measurement of the serving cell, and periodically updates the measurement of the serving cell.

When the measurement of the serving cell is updated (i.e., when the UE 110 re-measures the DL RS transmitted from the serving cell to derive updated measurement), the UE 110 determines whether an event condition is fulfilled. More specifically, when the measurement of the serving cell is updated, the UE 110 measures signal(s) of neighbor cell(s) and determines if there is any measurement of neighbor cell being specific margins greater than the measurement of the serving cell.

In these embodiments, the UE 110 measures a DL RS 1214 transmitted from the cell 121 (i.e., neighbor cell) and determines a measurement of the cell 121 is the specific margins greater than the updated measurement of the serving cell (i.e., when the event condition is fulfilled). Then, the UE 110 compares a cell offset of the cell 121 with at least one threshold and determines a state based on a result of comparing the cell offset of the cell 121 with the at least one threshold. Further, the UE 110 determines a scaling factor corresponding to the state, and adjusts the first time value based on the scaling factor.

Next, the UE 110 starts a timer of measurement reporting for the cell 121 and keeps monitoring the timer of measurement reporting for the cell 121. When the timer of measurement reporting for the cell 121 reaches the adjusted first time value, the UE 110 triggers measurement reporting procedure to transmit a measurement report to the serving cell for handover procedure.

It should be note that, in these embodiments, the measurement may be an L1-filtered or L3-filtered measurement quantity, and the measurement quantity may be RSRP, RSRQ, SINR, etc. The at least one threshold may be pre-configured by the network 100. The adjusted first time value may be used to only the timer of measurement reporting for the cell 121. In other words, each timer of measurement reporting may correspond to one adjusted first time value.

Moreover, the cell offset may be defined as:

O_{cell,n}=(Mn+Ofn+Ocn−Hys)−(Mp+Ofp+Ocp+Off)

while O_{cell,n} is cell offset of cell ‘n’, Mn is measurement result of cell ‘n’, Ofn is measurement object specific offset of the reference signal of the cell ‘n’, Ocn is cell specific offset of the cell ‘n’, Hys is hysteresis parameter, Mp is measurement result of the SpCell, Ofp is measurement object specific offset of the SpCell, Ocp is cell specific offset of the SpCell and Off is offset parameter.

For example, the UE 110 measures the DL RS from the serving cell to derive the measurement ‘R3’ of the serving cell, and periodically updates the measurement ‘R3’ of the serving cell.

When the measurement ‘R3’ of the serving cell is updated, the UE 110 measures signal(s) of neighbor cell(s) and determines the measurement ‘R4’ of the cell 121 is ‘N’ margins greater than the measurement ‘R3’ of the serving cell.

Then, the UE 110 compares a cell offset ‘Off’′ of the cell 121 with M2 number of thresholds and determines a state based on a result of comparing the cell offset ‘Off’′ of the cell 121 with M2 number of thresholds. Further, the UE 110 determines a state and a scaling factor corresponding to the state according to the below table 2.

TABLE 2

| | | Scaling factor |
|---|---|---|
| State | Criterion | (0 ≤ K2ᵢ ≤ 1) |
| 1 | Threshold₁ ≤ Off1 | K2₁ |
| 2 | Threshold₂ ≤ Off1 < Threshold₂ | K2₂ |
| 3 | Threshold₃ ≤ Off1 < Threshold₂ | K2₃ |
| . . . | . . . | . . . |
| M2 | Threshold_{M2} ≤ Off1 < Threshold_{M2-1} | K2_{M2} |

In this example, the cell offset ‘Off’′ is determined between the threshold₁ and threshold₂. Therefore, the state is determined as ‘2’ and the corresponding scaling factor is determined as ‘K2₂’. Then, a time value ‘TTT2’ of timeToTrigger of measurement reporting is adjusted by being multiplied by ‘K2₂’.

Next, the UE 110 starts a timer ‘T_{B}’ of measurement reporting for the cell 121, and keeps monitoring the timer ‘T_{B}’ of measurement reporting for the cell 121. When the timer ‘T_{B}’ of measurement reporting for the cell 121 reaches the adjusted time value ‘TTT2’, the UE 110 triggers measurement reporting procedure to transmit a measurement report to the serving cell for handover procedure.

FIG. 5 illustrate some embodiments of message transmissions in accordance with one novel aspect. In particular, the cell 121 is a serving cell serving the UE 110, and the network configuration includes the second time value (e.g., “T310” according to 3GPP Technical Specification) used for declaring RLF.

In these embodiments, the UE 110 measures a set of radio link monitoring-reference signal(s) (RLM-RS) 1216 from the cell 121 to derive a measurement of estimated DL radio link quality, and periodically updates the measurement of estimated DL radio link quality.

When the measurement is derived (or updated), the UE 110 determines an in-sync (IS) indication or an out-of-sync (OsS) indication according to the measurement. Then, the UE 110 determines if a timer of RLF detection is running.

If yes, the UE 110 compares the measurement with at least one threshold and determines a state based on a result of comparing the measurement with the at least one threshold. Then, the UE 110 determines a scaling factor corresponding to the state, and adjusts the second time value based on the scaling factor.

Next, the UE 110 determines if the UE 110 receives consecutive number (e.g., “N311” according to 3GPP Technical Specification) of IS indication(s). If no, the UE 110 determines the timer of RLF detection reaches the adjusted second time value.

Then, the UE 110 keeps monitoring the timer of RLF detection for the cell 121. When the timer of RLF detection for the cell 121 reaches the adjusted second time value, the UE 110 declares an RLF.

It should be note that, in these embodiments, the measurement of estimated DL radio link quality may be BLER, SNR, SINR, etc. The at least one threshold may be pre-configured by the network 100.

For example, the UE 110 measures the RLM-RS(s) 1216 from the cell 121 to derive a measurement ‘R5 of estimated DL radio link quality’, and periodically updates the measurement ‘R5’. When the measurement ‘R5’ is derived (or updated), the UE 110 determines an IS indication or an OsS indication according to the measurement ‘R5’. Then, the UE 110 determines that a timer ‘T_{c}’ of RLF detection is running.

Next, the UE 110 compares the measurement ‘R5’ with M3 number of thresholds, and determines a state and a scaling factor corresponding to the state according to the below table 3.

TABLE 3

| | | Scaling factor |
|---|---|---|
| State | Criterion | (0 ≤ K3ᵢ ≤ 1) |
| 1 | Threshold₁ ≤ R5 | K3₁ |
| 2 | Threshold₂ ≤ R5 < Threshold₁ | K3₂ |
| 3 | Threshold₃ ≤ R5 < Threshold₂ | K3₃ |
| . . . | . . . | . . . |
| M3 | Threshold_{M3} ≤ R5 < Threshold_{M3-1} | K3_{M3} |

In this example, the updated measurement ‘R5’ is determined greater than the threshold₁. Therefore, the state is determined as ‘1’ and the corresponding scaling factor is determined as ‘K3₁’. Then, a time value ‘T3’ of N310 of RLF is adjusted by being multiplied by ‘K3₁’.

Next, the UE 110 determines that the UE does not receive consecutive ‘N311’ number of IS indications, and keeps monitoring the timer ‘T_{c}’ of RLF. When the timer ‘T_{c}’ of RLF reaches the adjusted time value ‘T3’, the UE 110 declares an RLF.

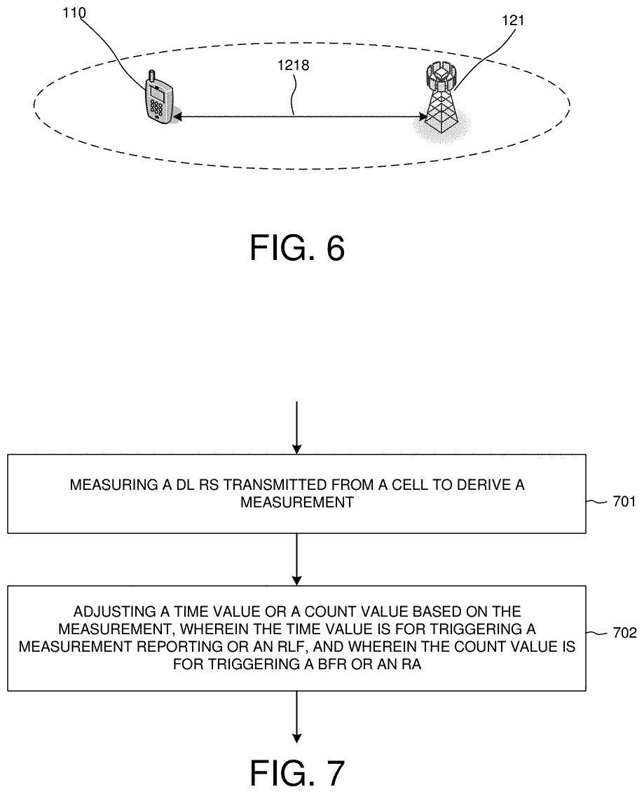

FIG. 6 illustrate some embodiments of message transmissions in accordance with one novel aspect. In particular, the cell 121 is a serving cell serving the UE 110, and the network configuration includes the count value (e.g., “beamFailureInstanceMaxCoount” according to 3GPP Technical Specification) used for BFR or RA procedure.

In these embodiments, the UE 110 measures a set of beam failure detection-reference signal(s) (BFR-RS) 1218 from the cell 121 to derive a measurement of estimated DL radio link quality, and periodically updates the measurement of estimated DL radio link quality.

When the measurement is derived (or updated), the UE 110 determines a beam failure instance indication according to the measurement. Then, the UE 110 determines if a beam failure instance indication is received from lower layers.

If yes, the UE 110 compares the measurement with at least one threshold and determines a state based on a result of comparing the measurement with the at least one threshold. Then, the UE 110 determines a scaling factor corresponding to the state, and adjusts the count value based on the scaling factor.

Next, the UE 110 increases a counter (e.g., “BFI_COUNTER” according to 3GPP Technical Specification) by 1. Then, the UE 110 keeps monitoring the counter. When the counter reaches the adjusted count value, the UE 110 triggers BFR or RA procedure.

It should be note that, in these embodiments, the measurement of estimated DL radio link quality may be BLER, SNR, SINR, etc. The at least one threshold may be pre-configured by the network 100.

For example, the UE 110 measures the set of BFR-RS 1218 from the cell 121 to derive a measurement ‘R6 of estimated DL radio link quality, and periodically updates the measurement ‘R6’. When the measurement ‘R6’ is derived (or updated), the UE 110 determines the beam failure instance indication according to the measurement ‘R6’, and determines that the beam failure instance indication is received from lower layers.

Next, the UE 110 compares the measurement ‘R6’ with M4 number of thresholds, and determines a state and a scaling factor corresponding to the state according to the below table 4.

TABLE 4

| | | Scaling factor |
|---|---|---|
| State | Criterion | (0 ≤ K4ᵢ ≤ 1) |
| 1 | Threshold₁ ≤ R6 | K4₁ |
| 2 | Threshold₂ ≤ R6 < Threshold₁ | K4₂ |
| 3 | Threshold₃ ≤ R6 < Threshold₂ | K4₃ |
| . . . | . . . | . . . |
| M4 | Threshold_{M3} ≤ R6 < Threshold_{M3-1} | K4_{M4} |

In this example, the updated measurement ‘R6’ is determined between the threshold₁ and the threshold₂. Therefore, the state is determined as ‘2’ and the corresponding scaling factor is determined as ‘K4₂’. Then, a count value ‘C1’ of beamFailureInstanceMaxCoount of BFR or RA is adjusted by being multiplied by ‘K4₂’.

Next, the UE 110 determines that the UE 110 increases the counter “BEI_COUNTER” by 1, and keeps monitoring the counter “BEI_COUNTER”. When the counter “BEI_COUNTER” reaches the adjusted count value ‘C1’, the UE 110 triggers BFR or RA procedure.

FIG. 7 is a flow chart of a method of early evaluation termination from both UE perspective in a 5G/NR network in accordance with one novel aspect. In step 701, the UE measures a DL RS or a set of DL RS transmitted from a cell to derive a measurement. In step 702, the UE adjusts a time value or a count value based on the measurement. The time value is for triggering measurement reporting procedure or declaring an RLF, and the count value is for triggering BFR or RA procedure.

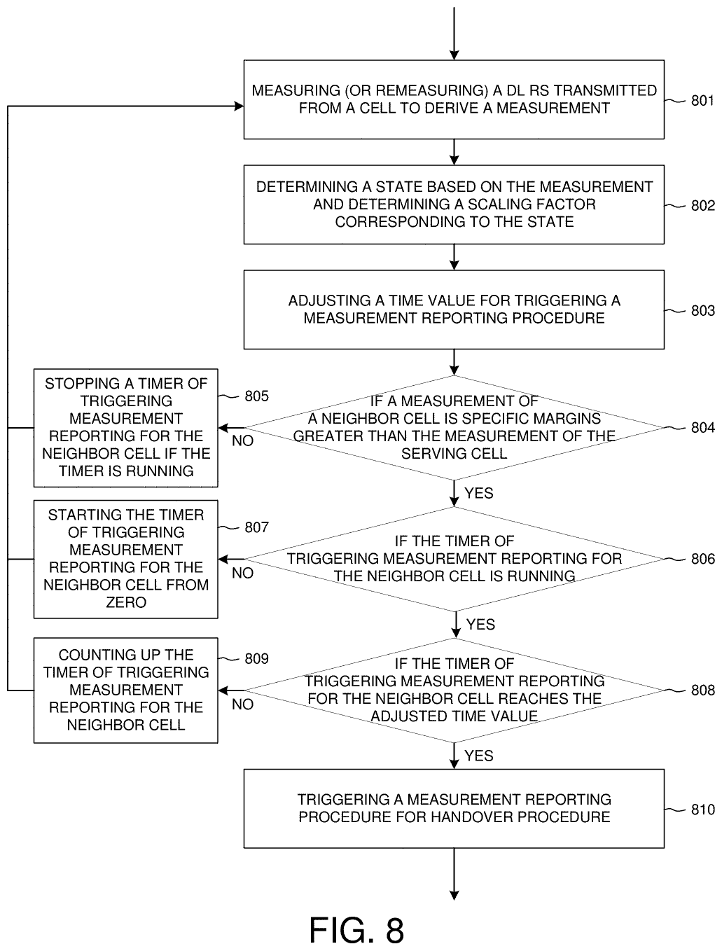

FIG. 8 is a flow chart of a method of early evaluation termination from both UE perspective in a 5G/NR network in accordance with one novel aspect. In step 801, the UE measures (or re-measures) a DL RS transmitted from a serving cell to derive a measurement. In step 802, the UE determines a state based on the measurement, and determines a scaling factor corresponding to the state. In step 803, the UE adjusts a time value for triggering a measurement reporting procedure.

In step 804, the UE determines if a measurement of a neighbor cell is specific margins greater than the measurement of the serving cell. If the result of step 804 is no, the flow of the method goes to step 805, the UE stops a timer of triggering measurement reporting for the neighbor cell if the timer is running, and then the flow of the method goes to step 801. In step 804, if the measurement of the neighbor cell is greater than the measurement of the serving cell, the flow of the method goes to step 806, the UE determines if the timer of triggering measurement reporting for the neighbor cell is running.

If the result of step 806 is no, the flow of the method goes to step 807, the UE starts the timer of triggering measurement reporting for the neighbor cell from zero, and then the flow of the method goes to step 801. If the result of step 806 is yes, the flow of the method goes to step 808, the UE determines if the timer of triggering measurement reporting for the neighbor cell reaches the adjusted time value.

If the result of step 808 is no, the flow of the method goes to step 809, the UE counts up the timer of triggering measurement reporting for the neighbor cell, and then the flow of the method goes to step 801. If the result of step 808 is yes, the flow of the method goes to step 810, the UE triggers a measurement reporting procedure for handover procedure.

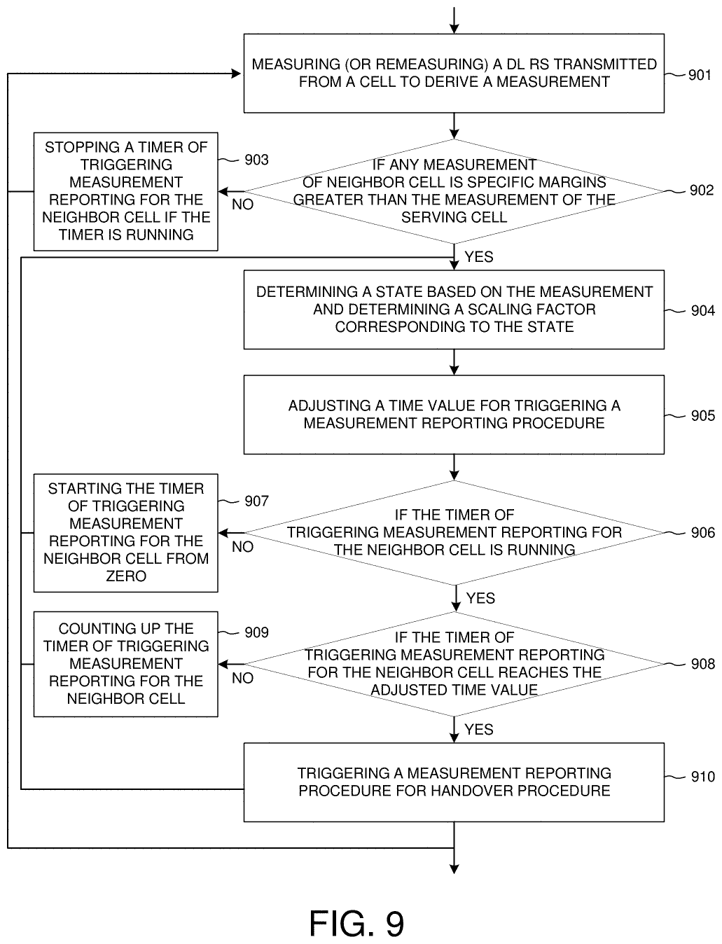

FIG. 9 is a flow chart of a method of early evaluation termination from both UE perspective in a 5G/NR network in accordance with one novel aspect. In step 901, the UE measures (or re-measures) a DL RS transmitted from a serving cell to derive a measurement. In step 902, the UE determines if any measurement of neighbor cell is specific margins greater than the measurement of the serving cell.

If the result of step 902 is no, the flow of the method goes to step 903, the UE stops a timer of triggering measurement reporting for the neighbor cell if the timer is running, and then the flow of the method goes to step 901. In step 902, if a measurement of a neighbor cell is greater than the measurement of the serving cell, the flow of the method goes to step 904, the UE determines a state based on a cell offset of the neighbor cell measurement, and determines a scaling factor corresponding to the state. In step 905, the UE adjusts a time value for triggering a measurement reporting procedure.

In step 906, the UE determines if the timer of triggering measurement reporting for the neighbor cell is running. If the result of step 906 is no, the flow of the method goes to step 907, the UE starts the timer of triggering measurement reporting for the neighbor cell from zero, and then the flow of the method goes to step 904 for processing next qualified neighbor cell. If the result of step 906 is yes, the flow of the method goes to step 908, the UE determines if the timer of triggering measurement reporting for the neighbor cell reaches the adjusted time value.

If the result of step 908 is no, the flow of the method goes to step 909, the UE counts up the timer of triggering measurement reporting for the neighbor cell, and then the flow of the method goes to step 904 for processing next qualified neighbor cell. If the result of step 908 is yes, the flow of the method goes to step 910, the UE triggers a measurement reporting procedure for handover procedure, and then the flow of the method goes to step 904 for processing next qualified neighbor cell.

In some embodiments, after checking all the qualified neighbor cell(s), the flow of the method may go to step 901.

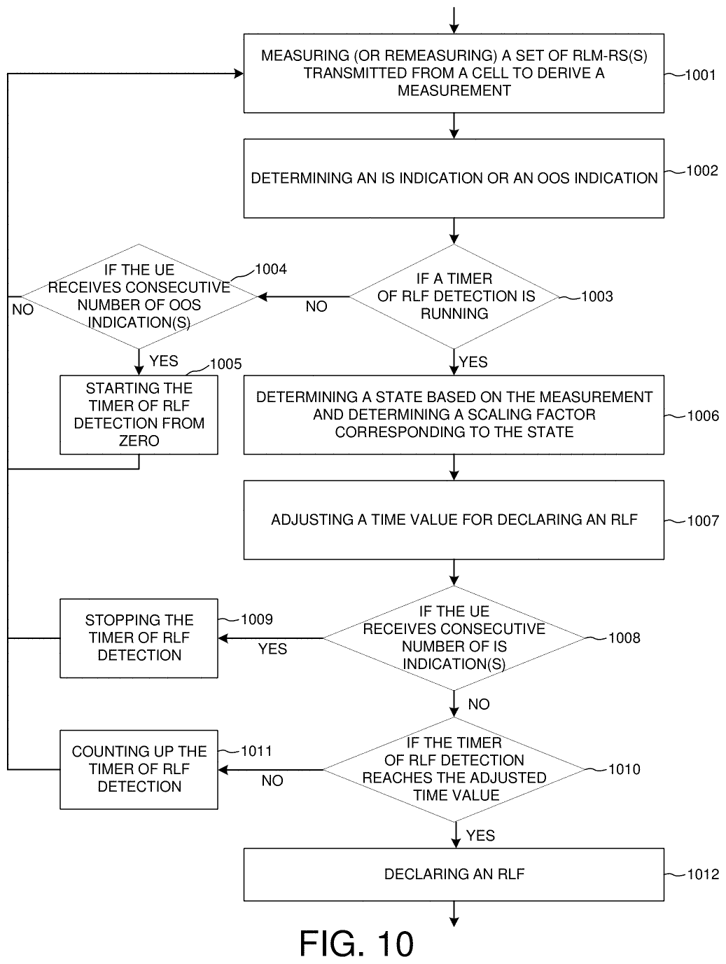

FIG. 10 is a flow chart of a method of early evaluation termination from both UE perspective in a 5G/NR network in accordance with one novel aspect. In step 1001, the UE measures (or re-measures) a set of RLM-RS(s) transmitted from a cell to derive a measurement of estimated DL radio link quality. In step 1002, the UE determines an IS indication or an OoS indication. In step 1003, the UE determines if a timer of RLF detection is running.

If the result of step 1003 is no, the flow of the method goes to step 1004, the UE determines if the UE receives consecutive number (e.g., “N310” according to 3GPP Technical Specification) of OoS indication(s). If the result of step 1004 is no, the flow of the method goes to step 1001. If the result of step 1004 is yes, the flow of the method goes to step 1005, the UE starts the timer of RLF detection from zero, and then the flow of the method goes to step 1001.

If the result of step 1003 is yes, the flow of the method goes to step 1006, the UE determines a state based on the measurement, and determines a scaling factor corresponding to the state. In step 1007, the UE adjusts a time value for declaring an RLF.

In step 1008, the UE determines if the UE receives a consecutive number (e.g., “N311” according to 3GPP Technical Specification) of IS indication(s). If the result of step 1008 is yes, the flow of the method goes to step 1009, the UE stops the timer of RLF detection, and then the flow of the method goes to step 1001. If the result of step 1008 is no, the flow of the method goes to step 1010, the UE determines if the timer of RLF detection reaches the adjusted time value.

If the result of step 1010 is no, the flow of the method goes to step 1011, the UE counts up the timer of RLF detection, and then the flow of the method goes to step 1001. If the result of step 1010 is yes, the flow of the method goes to step 1012, the UE declares an RLF.

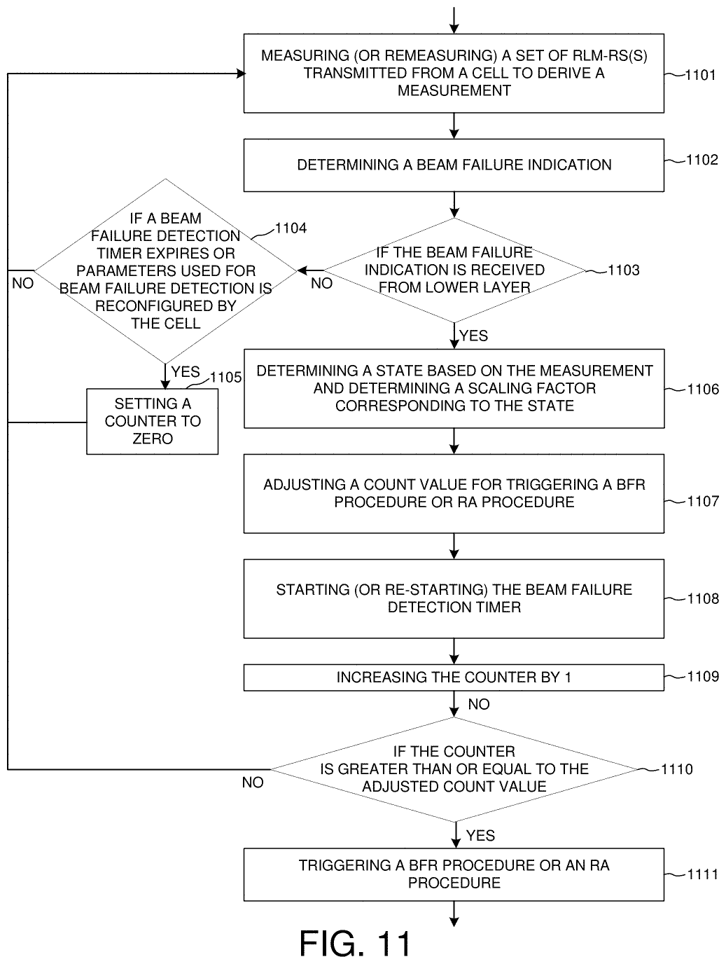

FIG. 11 is a flow chart of a method of early evaluation termination from both UE perspective in a 5G/NR network in accordance with one novel aspect. In step 1101, the UE measures (or re-measures) a set of BFD-RS(s) transmitted from a cell to derive a measurement of estimated DL radio link quality. In step 1102, the UE determines a beam failure indication. In step 1103, the UE determines if the beam failure indication is received from lower layer(s).

If the result of step 1103 is no, the flow of the method goes to step 1104, the UE determines if a beam failure detection timer (e.g., “beamFailureDetectionTimer” according to 3GPP Technical Specification) expires or parameters used for beam failure detection is reconfigured by the cell. If the result of step 1104 is no, the flow of the method goes to step 1101. If the result of step 1104 is yes, the flow of the method goes to step 1105, the UE sets a counter (e.g., “BFI_COUNTER according to 3GPP Technical Specification) to zero, and then the flow of the method goes to step 1101.

If the result of step 1103 is yes, the flow of the method goes to step 1106, the UE determines a state based on the measurement, and determines a scaling factor corresponding to the state. In step 1107, the UE adjusts a count value (e.g., “beamFailureInstanceMaxCount” according to 3GPP Technical Specification) for triggering BFR procedure or RA procedure.

In step 1108, the UE starts (or re-starts) the beam failure detection timer. In step 1109, the UE increases the counter (e.g., “BFI_COUNTER according to 3GPP Technical Specification) by 1. In step 1110, the UE determines if the counter is greater than or equal to the adjusted count value.

If the result of step 1110 is no, the flow of the method goes to step 1101. If the result of step 1110 is yes, the flow of the method goes to step 1111, the UE triggers a BFR procedure or an RA procedure.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

1. A method, comprising:
measuring, by a user equipment (UE), a downlink reference signal transmitted from a cell to derive a measurement; and
adjusting, by the UE, a time value or a count value based on the measurement, wherein the time value is for triggering a measurement reporting procedure or declaring a radio link failure, and wherein the count value is for triggering beam failure recovery or random access procedure.

2. The method of claim 1, wherein the step of adjusting the time value or the count value based on the measurement further comprises:
determining, by the UE, a scaling factor based on the measurement; and
adjusting, by the UE, the time value or the count value based on the scaling factor.

3. The method of claim 2, wherein the step of determining the scaling factor based on the measurement further comprises:
determining, by the UE, a state based on the measurement; and
determining, by the UE, the scaling factor corresponding to the state.

4. The method of claim 3, wherein the step of determining the state based on the measurement further comprises:
comparing, by the UE, the measurement with at least one threshold; and
determining, by the UE, the state based on a result of comparing the measurement with the at least one threshold.

5. The method of claim 4, wherein the at least one threshold is preconfigured by a network configuration.

6. The method of claim 1, wherein the cell is a serving cell, the UE adjusts the time value based on the measurement, and the method further comprises:
triggering, by the UE, the measurement reporting to transmit a measurement report to the serving cell when a timer of the measure reporting reaches the time value.

7. The method of claim 1, wherein the cell is a neighboring cell, the UE adjusts the time value, and the method further comprises:
triggering, by the UE, the measurement reporting to transmit a measurement report to a serving cell when a timer of the measurement reporting reaches the adjusted time value.

8. The method of claim 1, wherein the measurement reporting is triggered to transmit a measurement report to a serving cell when an event condition for a neighboring cell is fulfilled and the timer of the measurement reporting reaches the adjusted time value.

9. The method of claim 1, wherein the cell is a serving cell, the UE adjusts the time value, and the method further comprises:
declaring, by the UE, the radio link failure when a timer of the radio link failure reaches the adjusted time value.

10. The method of claim 1, wherein the cell is a serving cell, the UE adjusts the count value, and the method further comprises:
triggering, by the UE, the beam failure recovery or the random access when a counter of the beam failure reaches the adjusted count value.

11. A user equipment (UE) comprising:
a transceiver that:
receives a downlink reference signal transmitted from a cell;
an evaluation circuit that:
measures the downlink reference signal to derive a measurement; and
adjusts a time value or a count value based on the measurement, wherein the time value is for triggering a measurement reporting procedure or declaring a radio link failure, and wherein the count value is for triggering beam failure recovery or random access procedure.

12. The UE of claim 11, wherein the evaluation circuit further:
determines a scaling factor based on the measurement; and
adjusts the time value or the count value based on the scaling factor.

13. The UE of claim 12, wherein the evaluation circuit further:
determines a state based on the measurement; and
determines the scaling factor corresponding to the state.

14. The UE of claim 13, wherein the evaluation circuit further:
compares the measurement with at least one threshold; and
determines the state based on a result of comparing the measurement with the at least one threshold.

15. The UE of claim 14, wherein the at least one threshold is preconfigured by a network configuration.

16. The UE of claim 11, wherein the cell is a serving cell, the evaluation circuit adjusts the time value based on the measurement, and the evaluation circuit further:
triggers the measurement reporting to transmit a measurement report via the transceiver to the serving cell when a timer of the measure reporting reaches the adjusted time value.

17. The UE of claim 11, wherein the cell is a neighboring cell, the evaluation circuit adjusts the time value, and the evaluation circuit further:
triggers the measurement reporting to transmit a measurement report to a serving cell when a timer of the measurement reporting reaches the adjusted time value.

18. The UE of claim 11, wherein the measurement reporting is triggered to transmit a measurement report to a serving cell when an event condition for a neighboring cell is fulfilled and the timer of the measurement reporting reaches the adjusted time value.

19. The UE of claim 11, wherein the cell is a serving cell, the evaluation circuit adjusts the timer, and the evaluation circuit further:
declares the radio link failure when a timer of the radio link failure reaches the adjusted time value.

20. The UE of claim 11, wherein the cell is a serving cell, the evaluation circuit adjusts the count value, and the evaluation circuit further:
triggers the beam failure recovery or the random access when a counter of the beam failure reaches the adjusted counter value.
